(19) United States
(12) Patent Application Publication
(10) Pub. No.: US 2024/0301901 A1
(43) Pub. Date: Sep. 12, 2024

(54) REMOVABLE COUPLING DEVICE AND METHOD FOR COUPLNG PANELS

(71) Applicant: Honda Motor Co., Ltd., Tokyo (JP)

(72) Inventors: Brian E. DRESSEL, Worthington, OH (US); So NAKAURA, Wako (JP); Satoshi HAYASHI, Wako (JP); Travis W. CANNADY, Marysville, OH (US); Ju-Chia LEE, Pasadena, CA (US); Geemay CHIA, Pasadena, CA (US)

(21) Appl. No.: 18/181,136

(22) Filed: Mar. 9, 2023

(51) Int. Cl. F16B 5/06

(52) U.S. Cl. CPC F16B 5/0607; F16B 2005/0678; Y10T 403/348

(57) ABSTRACT

A removable coupling device and method for coupling panels of a modular panel system includes a at least one cooperative housing portion defining a housing recess configured to receive an associated frame of an associated panel and a rotational locking member movably disposed on the at least one cooperative housing portion to selectively lock an angular position between the at least one cooperative housing portion and the associated frame. The rotational locking member axially movable between a first axial position wherein the rotational locking member prevents relative rotation between the at least one cooperative housing portion and the associated frame and a second axial position wherein the rotational locking member allows relative rotation between the at least one cooperative housing portion and the associated frame.

### BACKGROUND

A variety of collapsible panel systems are known. Also a variety of collapsible furniture structures are known. Nonetheless, there remains a need for easily transportable collapsible structures, including panel systems that are collapsible and configurable into various useful structures, such as furniture, as well as for components of such systems. In particular, disadvantages of known collapsible furniture and panel systems includes the following: difficult to assemble and disassemble, difficult to transport, configurable in only a limited configuration or a few configurations, etc.

### BRIEF DESCRIPTION

According to one aspect, a removable coupling device for coupling panels of a modular panel system includes at least one cooperative housing portion defining a housing recess configured to receive an associated frame of an associated panel and a rotational locking member movably disposed on the at least one cooperative housing portion to selectively lock an angular position between the at least one cooperative housing portion and the associated frame. The rotational locking member axially movable between a first axial position wherein the rotational locking member prevents relative rotation between the at least one cooperative housing portion and the associated frame and a second axial position wherein the rotational locking member allows relative rotation between the at least one cooperative housing portion and the associated frame.

According to another aspect, a removable coupling device for coupling frames of panels includes a cooperative housing portion defining a housing recess in which a frame of a panel is removably received and a rotational locking member slidably arranged on the cooperative housing portion for selectively locking a relative angular position between the cooperative housing portion and the frame of the panel. The rotational locking member is slidable axially along the cooperative housing portion between a first position wherein the rotational locking member inhibits relative rotation between the cooperative housing portion and the frame of the panel and a second position wherein relative rotation between the cooperative housing portion and the frame is uninhibited by the rotational locking member.

According to a further aspect, a method for removably coupling panels of a modular panel system includes providing at least one cooperative housing portion defining a housing recess configured to receive a frame of a panel of the modular panel system and receiving the frame of the panel in the housing recess of the at least one cooperative housing portion. The method further includes moving a rotational locking member movably disposed on the at least one cooperative housing portion to selectively lock an angular position between the at least one cooperative housing portion and the frame.

### BRIEF DESCRIPTION OF THE DRAWINGS

FIG. 1 is a schematic perspective view of a modular panel system shown in an assembled state in a shade chair configuration, the modular panel system having coupling removable coupling devices for removably coupling adjacent panels according to one aspect of the present disclosure.

FIG. 2 is a perspective isolation view of one of the removable coupling devices of the modular panel system of FIG. 1.

FIG. 3 is an underside exploded perspective view of the removable coupling device of FIG. 2 shown with

FIG. 4 is a topside exploded perspective view of the removable coupling device of FIG. 2

FIG. 5 is a partial perspective view showing the removable coupling device of FIG. 2 coupling first and second frames of respective first and second panels of the modular panel system (shown with only the frames of the first and second panels).

FIG. 6 is a partial perspective view of the removable coupling device of FIG. 2 shown with a housing cover in an open state and a rotational locking member in an unlocked position.

FIG. 7 is a partial perspective view of the removable coupling device that is the same as FIG. 6 but shows the rotation locking member in a locked position.

FIG. 8 is a process flow diagram of a method for removably coupling panels of a modular panel system according to an exemplary embodiment of the present disclosure.

### DETAILED DESCRIPTION

It should, of course, be understood that the description and drawings herein are merely illustrative and that various modifications and changes can be made in the structures disclosed without departing from the present disclosure. Spatially relative terms may be used to describe an element and/or features relationship to another element(s) and/or feature(s) as, for example, illustrated in the figures. Moreover, any term of degree used herein, such as “substantially” and “approximately” means a reasonable amount of deviation of the modified word is contemplated such that the end result is not significantly changed.

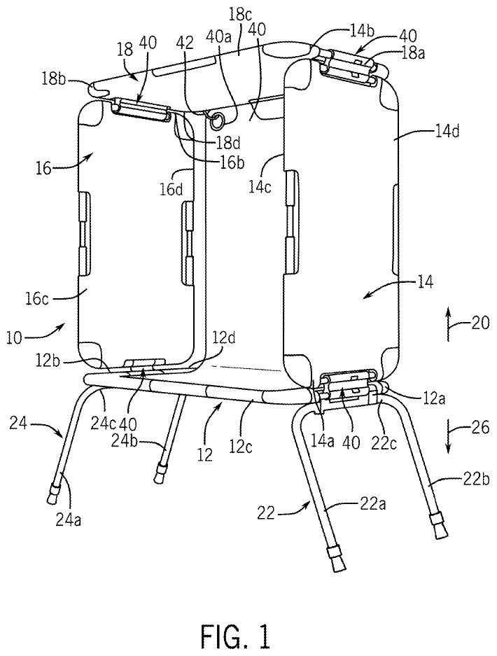

Referring now to the drawings, wherein like numerals refer to like parts throughout the several views, FIG. 1 illustrates a modular panel system 10 according to one embodiment of the present disclosure. More particularly, the modular panel system 10 of the illustrated embodiment is shown in an assembled state and particularly in a shade chair configuration. The modular panel system 10 of the illustrated embodiment includes a first panel 12, a second panel 14, a third panel 16, and a fourth panel 18. The second panel 14 is removably connected to the first panel 12 at a lower end thereof (i.e., at end edge portion 14a) and likewise the third panel 16 is removably connected to the first panel 12 at a lower end thereof (i.e., end edge portion 16a) but in laterally spaced relation relative to the second panel 14. The fourth panel 18 is removably connected to the second and third panels 14, 16 at respective upper ends thereof (i.e., end edge portions 14d and 16b) in spaced relation relative to the first panel 12.

As shown, in the assembled state in the shade chair configuration, the first panel 12 provides an elevated seating platform, such as for a person (not shown) to sit. The other panels 14, 16, 18 provide at least one of shade, privacy or an enclosure effect to the first panel 12. The modular panel system 10 of the illustrated embodiment is shown including four panels, i.e., panels 12, 14, 16, 18. However, it is to be understood by those skilled in the art that fewer than four panels could be included or more than four panels could be included as part of the modular panel system 10 and these could provide other configurations in the assembled state than the illustrated shade chair.

More particularly, each of the panels 12, 14, 16, 18 includes edge portions, particularly including end edge portions (e.g., end edge portions 12a, 12b, 14a, 14b, 16a, 16b, 18a, 18b) spaced apart from one another to define a panel length for a particular panel and lateral edge portions (e.g., lateral edge portions 12c, 12d, 14c, 14d, 16c, 16d, 18c, 18d) spaced apart from one another to define a width for the particular panel with each lateral edge portion extending from one of the end edge portions to the other of the end edge portions of a particular panel. In one embodiment, each of the panels 12, 14, 16, 18 can be identical to one another, though this is not required. Specifically, the first panel 12 can include edge portions 12a, 12b, 12c and 12d that include end edge portions 12a, 12b spaced apart from one another to define a panel length for the first panel 12 (i.e., first panel length), and lateral edge portions 12c, 12d spaced apart from one another to define a panel width for the first panel 12 (i.e., first panel width) with each of the lateral edge portions 12c, 12d extending from one of the end edge portions 12a or 12b (e.g., end edge portion 12a) to the other of the end edge portions 12a or 12b (e.g., end edge portion 12b).

In the illustrated embodiment, the second panel 14 can be the same as the first panel 12. Accordingly, the second panel 14 can likewise include end edge portions 14a, 14b, 14c, 14d, including end edge portions 14a, 14b spaced apart from one another to define a panel length of the second panel 14 (i.e., second panel length), and lateral edge portions 14c, 14d spaced apart from one another to define a panel width of the second panel 14 (i.e., second panel width) with each of the lateral edge portions 14c, 14d extending from one of the end edge portions 14a or 14b (e.g., end edge portion 14a) to the other of the end edge portions 14a or 14b (e.g., end edge portion 14b). Since the panels 12 and 14 are identical to one another in the illustrated embodiment, the second panel length and second panel width of the second panel 14 are, respectfully, the same as the first panel length and the first panel width of the first panel 12. As will be described in more detail below, the first and second panels 12, 14 are configured to be removably coupled to one another (e.g., by the coupling device 40) by having respective edge portions, particularly edge portions 12a and 14a of each of the first and second panels 12, 14, arranged longitudinally adjacent to one another and removably coupled together. This removable coupling can be enabled by a removable coupling device or member, such as removable coupling device 40, as will be described in more detail below.

As already mentioned, the third and fourth panels 16, 18 can also be identical to the first panel 12. Accordingly, each of these panels 16, 18 includes edge portions, including end edge portions (end edge portions 16a, 16b for the third panel 16 and end edge portions 18a, 18b for the fourth panel 18) spaced apart from one another to define a panel length, and lateral edge portions (lateral edge portions 16c, 16d for the third panel 16 and lateral edge portions 18c, 18d for the fourth panel 18) spaced apart from one another to define a panel width with each of the lateral edge portions extending from one of the end edge portions to the other of the end edge portions. The third panel 16 and the fourth panel 18 are each configured to be removably coupled to the other panels 12, 14, 16, 18 by additional removable coupling devices 40. For example, in FIG. 1, end edge portion 16a of the third panel 16 is arranged longitudinally adjacent the end edge portion 12b and removably coupled thereto by a second removable coupling device 40. End edge portion 16b of the third panel 16 is arranged longitudinally adjacent the end edge portion 18b of the fourth panel 18 and removably coupled thereto by a further removable coupling device 40. End edge portion 14b is arranged longitudinally adjacent the end edge portion 18a of the fourth panel and removably coupled thereto by still another removable coupling device 40.

Since the third panel 16 is the same as the first and second panels 12, 14, the panel length and panel width of the third panel 16 are, respectively, the same as the panel length and panel width of the first panel 12 and the second panel 14. Similarly, since the fourth panel is the same in size and shape as the first, second, and third panels 12, 14, 16, the panel length and panel width of the fourth panel 18 are, respectively, the same as the panel length and panel width of each of the first panel 12, the second panel 14, and the third panel 16.

In the assembled configuration of FIG. 1, the first, second, third, and fourth panels 12, 14, 16, 18 are specifically orthogonally arranged to form a rectangular structure or configuration, which can be referred to as a shade chair configuration as mentioned above. In particular, the end edge portions of the first, second, third, and fourth panels 12, 14, 16, 18 are secured to one another by the removable coupling devices 40 such that the second and third panels, 14, 16 are spaced apart from one another and are secured to both the first and fourth panels 12, 18 with the first and fourth panels 12, 18 spaced apart from one another. In particular, the second and third panels 14, 16 extend in a first direction illustrated by arrow 20 away from the first panel 12.

In addition, as shown, the modular panel system 10 can include at least one leg attachment member, such as the illustrated leg attachment members 22, 24. In particular, in the illustrated embodiment, the at least one leg attachment member includes two leg attachment members 22, 24. Each of these leg attachment members 22, 24 is removably secured to the first panel 12 at the end edge portions 12a, 12b and extends substantially in a second direction illustrated by arrow 26 away from the first panel 12 that is opposite the first direction represented by arrow 20. As shown, the first leg attachment member 22 can be removably secured to a first one of the end edge portions of the first panel 12, namely the end edge portion 12a, and the second leg attachment member 24 can be secured to a second one of the end edge portions of the first panel 12, namely the end edge portion 12b that is opposite the first end edge portion 12a.

The leg attachment members 22, 24 in the illustrated embodiment are each formed as a U-shaped structure. Accordingly, the first leg attachment member 22 includes leg portions 22a, 22b connected together by an attachment portion 22c. The attachment portion 22c is removably coupled to the end edge portion 12a. Likewise, the second leg attachment member 24 can include leg portions 24a, 24b and an attachment portion 24c removably coupled to the end edge portion 12b. The attachment portions 22c, 24c can be removably coupled to the respective end edge portions 12a, 12b of the first panel 12 through any known removable connection as will be understood and appreciated by those skilled in the art. For example, the leg attachment portions 22c, 24c can include a snap-fit removable coupling, a screw-type coupling, a cam-lock type coupling, etc. (none of which are shown). Additionally, the leg attachment members 22, 24, and particularly the leg portions 22a, 22b, 24a, 24b thereof can be or include telescoping legs so as to be height adjustable. In the assembled state and configuration of FIG. 1 (i.e., the shade chair configuration), adjusting the telescoping height of the leg portions 22a, 22b, 24a, 24b can selectively raise and lower a desired height of the panels 12, 14, 16, 18 as might be advantageous when choosing a height for the first panel 12 on which to sit.

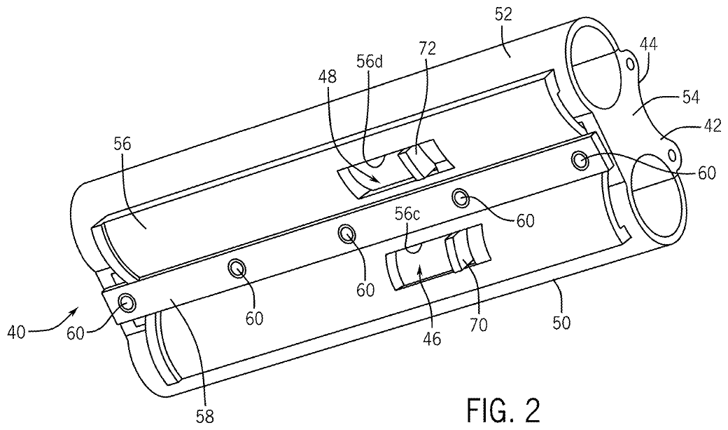

With additional reference to FIG. 2, one of the removable coupling devices 40 of the modular panel system 10 is illustrated in isolation from the modular panel system 10. In particular, and as mentioned above, the removable coupling device 40 is provided for removably coupling the panels, for example, panels 12, 14, 16, 18, of the modular panel system 10, and allowing the panels 12, 14, 16, 18 to be angularly moved relative to one another when coupled by the coupling device 40. In particular, the modular panel system 10 of the illustrated embodiment of FIG. 1 includes four (4) removable coupling devices 40. In one embodiment, the modular panel system 10 is that described in commonly owned U.S. patent application Ser. No. XX/XXX,XXX, entitled “MODULAR PANEL SYSTEM, KIT, AND METHOD” (Attorney Docket HRA-53741) that is filed concurrent with the subject application on Mar. 9, 2023, and is expressly incorporated herein in its entirety by reference, but substitutes the coupling member 40 described herein.

Each removable coupling device 40 includes at least one cooperative housing portion (e.g., first cooperative housing portion 42 and second cooperative housing portion 44) defining a housing recess (e.g., housing recesses 42a, 42b) configured to receive an associated frame of an associated panel (e.g., frame 28 of panel 12 and frame 30 of panel 14). The removable coupling device 40 further includes at least one rotational locking member (e.g., rotational locking members 46, 48) movably disposed on the at least one cooperative housing portion to selectively lock an angular position between the at least one cooperative housing portion and the frame (e.g., frame 28 or 30) that the at least one cooperative housing portion receives.

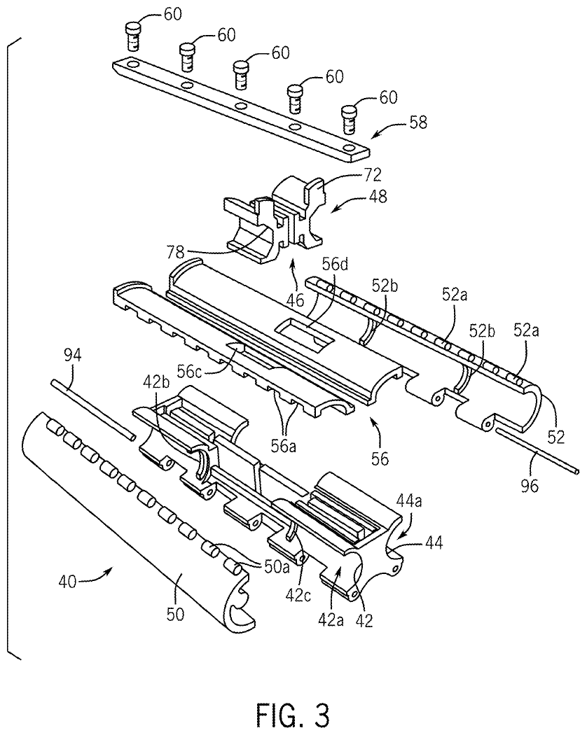

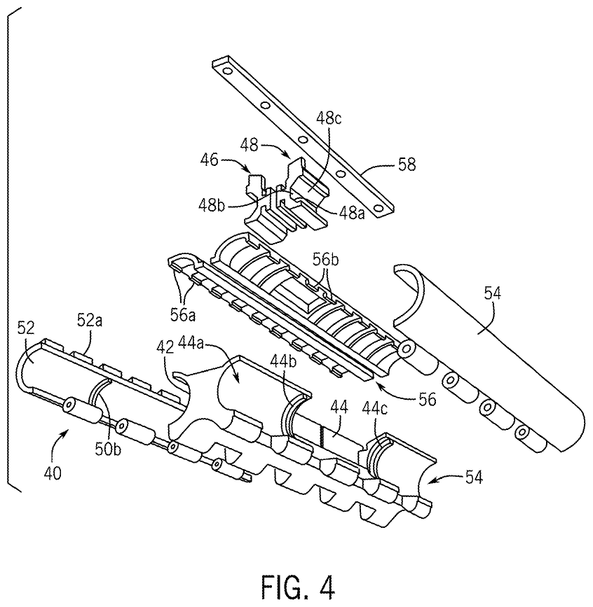

More particularly, with additional reference to FIGS. 3 and 4, the at least one cooperative housing portion of the illustrated coupling device 40 includes a first cooperative housing portion 42 and a second cooperative housing portion 44. In particular, the first cooperative housing portion 42 defines housing portion recess 42a for receiving frame 28 of the first panel 12 and the second cooperative housing portion 44 defines a housing recess 44a configured to receive the frame 30 of the second panel 14. In the illustrated embodiment, the second cooperative housing portion 44 is integrally formed with the first cooperative housing portion 42. Specifically, in the illustrated embodiment, the cooperative housing portions 42, 44 are integrally formed as shown in FIGS. 3 and 4, though this is not required. For example, the housing portions 42, 44 could be separately formed and fixedly coupled together.

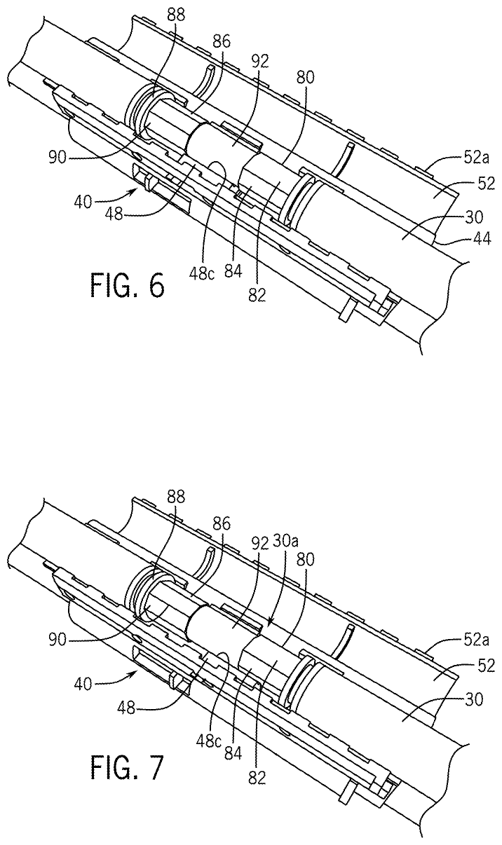

The at least one rotation locking member includes a first rotational locking member 46 movably disposed on the first cooperative housing portion 42 and a second rotational locking member 48 movably disposed on the second cooperative housing portion 44. For example, when removably coupling the first and second panels 12 and 14 together, the first rotational locking member 46 is movably disposed to selectively lock an angular position between the first cooperative housing portion 42 and the frame 28 of the first panel 12 and the second rotational locking member 48 is movably disposed to selectively lock an angular position between the second cooperative housing portion 44 and the frame 30 of the second panel 14. Each rotational locking member 46, 48 is specifically axially movable between a first axial locking position (e.g., shown in FIG. 7) wherein the rotational locking member (i.e., members 46, 48) prevents relative rotation between the at least one cooperative housing portion (i.e., portions 42 and 44) and the associated frame and a second axial position (e.g., shown in FIG. 6) wherein the rotational locking member 46 or 48 allows relative rotation between the at least one cooperative housing portion and the associated frame.

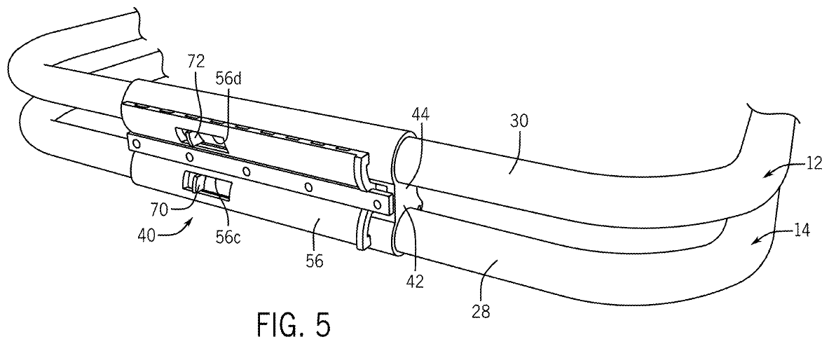

As shown, a housing cover 50 or 52 is hingedly secured to the at least one cooperative housing portion. Specifically, a first housing cover 50 is hingedly secured to the first cooperative housing portion 42 via hinge pin 94 and a second housing cover 52 is hingedly secured to the second cooperative housing portion 44 via a hinge pin 96. Each housing cover 50, 52 is pivotable between a closed position (shown in FIGS. 2 and 5) and an open position (shown in FIG. 6). In the closed position, the housing covers 50, 52 respectively prevent removal of the frame 28 of the first panel 12 from the first cooperative housing portion 42 and prevent removable of the frame 30 of the second panel form the second cooperative housing portion 44. In the respective open positions, the frame 28 of the first panel 12 is removable from the first cooperative housing portion 42 and the frame 30 of the second panel 14 is removable from the second cooperative housing portion 44.

In the illustrated embodiment, each of the first and second cooperative housing portions 42, 44 are together and integrally formed from a main body member 54 to which the first and second housing covers 50, 52 are pivotally connected. The main body member 54 partially defines the first housing recess 42a and the second housing portion recess 44a as shown. The removable coupling device 40 further includes an auxiliary body member 56 fixedly secured to the main body member 54. In particular, the auxiliary body member 56 of the illustrated embodiment is secured by mounting plate 58 having fasteners 60, such as threaded screws or the like, securing the mounting plate 58 to the main body member 54 to thereby secure the auxiliary body member 56 to the main body member 54. In alternate embodiments, the main body member 54 and the auxiliary body member 56 could be integrally formed and/or additional components could be assembled to form the structure provided by the main body member 54 and the auxiliary body member 56.

One of the auxiliary body member 56 or the respective housing covers 50, 52 can include at least one tab (for example, tabs 50a, 52a) selectively receivable in at least one corresponding tab slot (for example, tab slots 56a, 56b) defined in the other of the auxiliary body member 56 or the housing covers 50, 52 for securing the housing covers 50, 52 in respective closed positions. More particularly, in the illustrated embodiment, the housing cover 50 includes tabs 50a spaced apart along a longitudinal extent of the housing cover 50 for receipt in corresponding tab slots 56a on the auxiliary member 56 for selectively securing the housing cover 50 in the closed position. Likewise, the housing cover 52 includes tabs 52a spaced apart along a longitudinal extent of the housing cover 52 for receipt in the corresponding tab slots 56b on the auxiliary member 56 for selectively securing the housing cover 52 in respective closed position. The tabs 50a, 52a can be secured in the tab slots 56a, 56b via a friction fit or snap fit connection, or some other selectively lockable but removable connection.

Each of the housing covers 50, 52 can additionally include at least one radial tab, for example radial tabs 50b, 50c on the first housing cover 50 and radial tabs 52b, 52c on the second housing cover 52, extending radially inwardly to matingly engage with at least one corresponding circumferential groove (for example, circumferential grooves 64 and 66 defined in the frame 30 of the second panel 14 shown in FIGS. 6 and 7) to axially inhibit relative movement between their respective cooperative housing portions 42, 44 and the frames 28, 30 of the first and second panels 12, 14 respectively received therein. Similarly, each of the cooperative housing portions 42, 44 can include at least one radial tab (for example, radial tabs 42b, 42c on the first cooperative housing portion 42 and radial tabs 44b, 44c on the second cooperative housing portion 44) extending radially inwardly into the respective housing recesses 42a, 44a that are adapted to receive the frames 28, 30 of the first and second panels 12, 14. The radial tabs 42b, 44b can matingly engage with the circumferential grooves (e.g., grooves 64, 66 in the frame 30 as shown in FIGS. 6 and 7) defined in the respective frames 28, 30 of the first and second panels 12, 14 to axially inhibit relative movement between the cooperative housing portions 42, 44 and the frames 28, 30 of the first and second panels 12, 14. In particular, in the illustrated embodiment, the at least one radial tab of the first housing portion 42 includes tabs 42b, 42c as a pair of axially spaced apart radial tabs 42b that flank the rotational locking member 46 and the at least one radial tab of the second housing portion 44 includes tabs 44b, 44c as a pair of axially spaced apart radial tabs 44b, 44c that flank the rotational locking member 48. In accord with this construction, the at least one circumferential groove can include a pair of spaced apart grooves 64, 66 on the frame 30 of the second panel 14 and likewise, though not shown, a pair of spaced apart circumferential grooves on the frame 28 of the first panel 12 for respectively receiving the tabs 42b, 42c and 44b, 44c.

With additional references to FIG. 5, the rotational locking members 46, 48 can include, respectively, actuator tabs 70, 72 for manually manipulating each of the rotational locking members 46, 48 between the first axial position and the second axial position. As shown, the actuator tab 70 extends through a tab aperture 56c in the first cooperative housing portion 42, with the tab aperture 56c specifically defined in the auxiliary body member 56, so as to be disposed adjacent the first cooperative housing portion 42. Likewise, the actuator tab 72 extends through a tab aperture 56d in the second cooperative housing portion 44, with the tab aperture 56d specifically defined in the auxiliary body member 56, so as to be disposed adjacent the second cooperative housing portion 44.

Now with additional reference to FIG. 6, the removable coupling between the removable coupling device 40, and particularly the second cooperative housing portion 44, and the frame 30 of the second panel 14 will be described in particular detail. It is to be appreciated, however, that this same removable coupling is applicable to the removable coupling between the removable coupling device 40, and particularly the first cooperative housing portion 42 thereof, and the frame 28 of the first panel 14. As shown, the rotational locking member 48 includes at least one engagement surface, for example engagement surfaces 48a, 48b, 48c (see FIG. 4), that is axially aligned and mates with at least one keyed surface, for example keyed surfaces 80, 82, 84, defined on the frame 30 at the second panel 14 to prevent rotation of the frame 30 within the cooperative housing portion 44 when the rotational locking member 48 is in the first axial locking position (the position shown in FIG. 7). In contrast, the at least one engagement surface, i.e., engagement surfaces 48a, 48b, 48c, are axially offset from the at least one keyed surface, i.e., keyed surfaces 80, 82, 84, when in the second unlocked axial position (the position shown in FIG. 6).

In particular, in the illustrated embodiment, the at least one engagement surface can include engagement surfaces 48a, 48b, 48c defined by the rotational locking member 48. The at least one keyed surfaces can include a first set of keyed surfaces 80, 82, 84 disposed circumferentially about the frame 30 of the second panel 14 that are engaged by the engagement surfaces 48a, 48b, 48c when the rotational locking member 48 is in the locked position wherein the engagement surfaces 48a, 48b, 48c are axially aligned, at least in part, with the keyed surfaces 80, 82, 84. Again, movement of the rotational locking member 48 between the locked position (FIG. 7) and the unlocked position (FIG. 6) can be implemented via manual manipulation of the tab actuator 72. When the engagement surfaces 48a, 48b, 48c are axially aligned with non-keyed circumferential surface or section 92, as shown in FIG. 6, rotation of the frame 30 relative to the first cooperative housing portion 44 is allowed.

The at least one keyed surface can include additional keyed surfaces so that such keyed surfaces are provided around an entire circumference of the frame 30. Additionally, another set of keyed surfaces, including keyed surfaces 86, 88, 90, can be disposed circumferentially about the frame 30 of the second panel 14 in axial spaced relation relative to the first set of keyed surfaces 80, 82, 84. These keyed surfaces 86, 88, 90 can be engaged by the engagement surfaces 48a, 48b, 48c when the removable coupling device 40 is flipped axially on the frame 30 of the second panel 14. In the illustrated embodiment, the keyed surfaces 80, 82, 84 of the first set of keyed surfaces and the keyed surfaces 86, 88, 90 of the second set of keyed surfaces are circumferentially disposed about the frame 30 at a reduced frame portion 30a of the frame 30. Specifically, the sets of keyed surfaces can include diametrically opposed keyed surfaces. That is, at least one of the keyed surfaces 80, 82, 84 can be diametrically opposed to another of the keyed surfaces 80, 82, 84. Likewise, and as shown, the engagement surfaces 48a, 48b, 48c of the rotational locking member 48 can include having the engagement surfaces 48a, 48c in diametrically opposed positions.

By this arrangement, the rotational locking member 48 is slidably arranged on the second cooperative housing portion 44 for selectively locking a relative angular position between the second cooperative housing portion 44 and the frame 30 of the second panel 14 The rotational locking member 48 is slidable axially along the cooperative housing portion 44 between the first axial position (FIG. 7) wherein the rotational locking member 48 inhibits relative rotation between the cooperative housing portion 44 and the frame 30 of the second panel 14 and the second axial position (FIG. 6) wherein relative rotation between the cooperative housing portion 44 and the frame 30 of the second panel 14 is uninhibited by the rotational locking member 48. In particular, between the sets of keyed surfaces 80, 82, 84 and 86, 88, 90, the non-keyed section 92 is provided on the frame 30 at the reduced diameter portion 30a such that when the engagement surfaces 48a, 48b, 48c of the rotational locking member 48 are axially aligned with the non-keyed section 92, relative rotation is allowed such that the frame 30 of the second panel 14 can be rotated relative to the second cooperative housing portion 44. When the rotational locking member 48 is slid to the first axial position, the engagement surfaces 48a, 48b, 48c matingly engage the keyed surfaces 80, 82, 84 disposed on the frame 30 of the second panel 14 wherein this engagement by the keyed surfaces 80, 82, 84 prevents rotation between the cooperative housing portion 44 and the frame 30 of the second panel 14. Notably, the removable coupling device 40 could be reversed on the frame 30 of the second panel 14 so that the movement of the rotational locking member 48 from and between the first and second axial positions could result in the engagement surfaces 48a, 48b, 48c of the rotational locking member 48 matingly engaging the keyed surfaces 86, 88, 90 instead of the keyed surfaces 80, 82, 84.

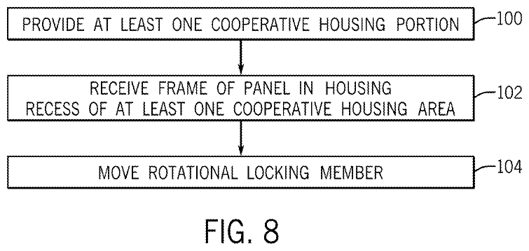

With reference now to FIG. 7, a method for removably coupling panels of a modular panel system will be described. In particular, in FIG. 8, the method will be described with particular reference to the panels 12, 14 of the modular panel system 10 and the removable coupling device 40. It is to be appreciated, however, that the method could be applied to any of the other panels (for example panels 16 and 18) of the modular panel system 10 or any connection between the panels 12, 14, 16, 18 in the modular panel system 10. Further, the method could be used with other modular panel systems and/or other panels and should not be considered limited to the modular panel system 10 discussed herein, nor to the removable coupling device described herein.

In the method, at 100, at least one cooperative housing portion is provided of a removable coupling device. In particular, the cooperative housing portions 42, 44 of the removable coupling device 40 discussed hereinabove can be provided. As already discussed, the cooperative housing portions 42, 44 can respectively define housing recesses 42a, 44a configured to receive respective frames 30 of the panels 12, 14 of the modular panel system 10. At 102, the frame 30 of the panel 12 is received in the housing recess 42a of the first cooperative housing portion 42. This step 102 can also include receiving the frame 30 of the second panel 14 in the housing recess 44a of the second cooperative housing portion 44 if desired. Then, at 104, the rotational locking member 46 that is movably disposed on the cooperative housing portion 42 is moved to a selectively locking angular position between the cooperative housing portion and the associated frame. In particular, with respect to the cooperative housing portion 42, the rotational locking member 46 is moved along the cooperative housing portion 42 to selectively lock the angular position between the cooperative housing portion 42 and the frame 30 of the first panel 12. Optionally, the rotational locking member 48 can be moved along the cooperative housing portion 44 to selectively lock the angular position between the cooperative housing portion 44 and the frame 30 of the second panel 14. Also optionally, the method can include angularly moving the panel 12 relative to the cooperative housing portion 42 and/or angularly moving the panel 14 relative to the cooperative housing portion 44, particularly after the respective frames 30 of the respective panels 12, 14 are received in the housing recesses 42a, 44a and before the rotational locking member 46 is moved to selectively lock the relative angular positions.

It will be appreciated that various of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

1. A removable coupling device for coupling panels of a modular panel system, the device comprising:
at least one cooperative housing portion defining a housing recess configured to receive an associated frame of an associated panel; and
a rotational locking member movably disposed on the at least one cooperative housing portion to selectively lock an angular position between the at least one cooperative housing portion and the associated frame, the rotational locking member axially movable between a first axial position wherein the rotational locking member prevents relative rotation between the at least one cooperative housing portion and the associated frame and a second axial position wherein the rotational locking member allows relative rotation between the at least one cooperative housing portion and the associated frame.

2. The removable coupling device of claim 1 further including:
a housing cover hingedly secured to the at least one cooperative housing portion, the housing cover pivotable between a closed position wherein the housing cover prevents removal of the associated frame from the at least one cooperative housing portion and an open position wherein the associated frame is removable from the at least one cooperative housing portion.

3. The removable coupling device of claim 2 wherein the at least one cooperative housing portion includes:
a main body member partially defining the housing recess and having the housing cover pivotally connected thereto; and
an auxiliary body member fixedly secured to the main body member and further defining the housing recess.

4. The removable coupling device of claim 3 wherein one of the auxiliary body member or the housing cover includes at least one tab selectively receivable in at least one corresponding tab slot defined in the other of the auxiliary body member or the housing cover for securing the housing cover in the closed position.

5. The removable coupling device of claim 2 wherein the housing cover includes at least one radial tab extending radially inwardly to matingly engage with at least one corresponding circumferential groove defined in the associated frame to axially inhibit relative movement between the at least one cooperative housing portion and the associated frame.

6. The removable coupling device of claim 1 wherein the rotational locking member includes an actuator tab for manually manipulating the rotational locking member between the first axial position and the second axial position, the actuator tab extending through a tab aperture defined in the at least one cooperative housing portion.

7. The removable coupling device of claim 1 wherein the rotational locking member includes at least one engagement surface that is axially aligned and mates with at least one keyed surface defined on the associated frame to prevent rotation of the associated frame within the at least one cooperative housing portion when in the first axial position, and wherein the at least one engagement surface is axially offset from the at least one keyed surface when in the second axial position.

8. The removable coupling device of claim 7 wherein the at least one keyed surface is a plurality of keyed surfaces disposed circumferentially about the associated frame.

9. The removable coupling device of claim 7 wherein the at least one keyed surface includes a first plurality of keyed surfaces disposed circumferentially about the associated frame and a second plurality of keyed surfaces disposed circumferentially about the associated frame, the second plurality of keyed surfaces axially spaced apart from the first plurality of keyed surfaces.

10. The removable coupling device of claim 1 wherein the at least one cooperative housing portion includes at least one radial tab extending radially inwardly into the housing recess, the at least one radial tab matingly engaging at least one corresponding circumferential groove defined in the associated frame to axially inhibit relative movement between the at least one cooperative housing portion and the associated frame.

11. The removable coupling device of claim 9 wherein the at least one radial tab of the at least one cooperative housing portion includes a pair of spaced apart radial tabs that are axially spaced apart from one another and flanking the rotational locking member, and wherein the at least one corresponding circumferential groove includes a pair of spaced apart circumferential grooves for receiving the pair of spaced apart radial tabs.

12. The removable coupling device of claim 1 wherein the at least one cooperative housing portion includes a first cooperative housing portion and a second cooperative housing portion, and wherein the housing recess if a first housing recess and the associated frame of the associated panel is a first associated frame of a first associated panel, and further wherein the second cooperative housing portion defines a second housing recess configured to receive a second associated frame of a second associated panel, the second cooperative housing portion integrally formed or fixedly secured to the first cooperative housing portion, and wherein the rotational locking member also selectively locks an angular position between the second cooperative housing portion and the associated second frame.

13. A removable coupling device for coupling frames of panels, comprising:
a cooperative housing portion defining a housing recess in which a frame of a panel is removably received; and
a rotational locking member slidably arranged on the cooperative housing portion for selectively locking a relative angular position between the cooperative housing portion and the frame of the panel, the rotational locking member slidable axially along the cooperative housing portion between a first position wherein the rotational locking member inhibits relative rotation between the cooperative housing portion and the frame of the panel and a second position wherein relative rotation between the cooperative housing portion and the frame is uninhibited by the rotational locking member.

14. The removable coupling device of claim 12 wherein the rotational locking member includes at least one engagement surface that matingly engages at least one keyed surface disposed on the frame of the panel when the rotational locking member is in the first position wherein engagement by the at least one engagement surface with the at least one keyed surface prevents relative rotation between the cooperative housing portion and the frame of the panel.

15. The removable coupling device of claim 14 wherein the at least one engagement surface includes first and second engagement surfaces and the at least one keyed surface includes at least diametrically opposed keyed surfaces, and wherein the first and second engagement surfaces abuttingly engage the diametrically opposed keyed surfaces when the rotational locking member is in the first position.

16. The removable coupling device of claim 13 wherein the at least one engagement surface is axially offset from the at least one keyed surface when the rotational locking member is in the second position.

17. The removable coupling device of claim 13 wherein the at least one keyed surface includes a first set of circumferentially keyed surfaces that are abuttingly engaged by the at least one engagement surface of the rotational locking member when in the first position and when the cooperative housing portion is disposed relative to the frame member in a first orientation and wherein the at least one keyed surface includes a second set of circumferentially keyed surfaces axially spaced apart from the first set of circumferentially keyed surfaces that are abutting engaged by the at least one engagement surface of the rotational locking member when in the first position and when the cooperative housing position is disposed relative to the frame member in a second orientation that is axially reversed relative to the first orientation.

18. A method for removably coupling panels of a modular panel system, comprising:
providing at least one cooperative housing portion defining a housing recess configured to receive a frame of a panel of the modular panel system;
receiving the frame of the panel in the housing recess of the at least one cooperative housing portion; and
moving a rotational locking member movably disposed on the at least one cooperative housing portion to selectively lock an angular position between the at least one cooperative housing portion and the frame.

19. The method of claim 18 further including:
angularly moving the panel relative to the cooperative housing portion after the frame of the panel is received in the housing recess and before the rotational locking member is moved to selectively lock the angular position.

20. The method of claim 18 wherein moving the rotational locking member includes axially sliding the rotational lock member to axially move an engagement surface of the rotational locking member into abutting contact with a keyed surface of the frame of the panel to prevent relative rotation between the frame and the cooperative housing portion.
